(19) United States
(12) Patent Application Publication
(10) Pub. No.: US 2025/0384697 A1
(43) Pub. Date: Dec. 18, 2025

(54) IMPROVED PROCESS FOR DETECTING OBJECTS BY MEANS OF A NEURAL NETWORK

(71) Applicant: Continental Autonomous Mobility Germany GmbH, Ingolstadt (DE)

(72) Inventors: Lucien GARCIA, Tournefeuille (FR); Hugo CHOCHOY, Toulouse (FR); Jorge Francisco MADRIGAL DIAZ, Saint Jean (FR)

(73) Assignee: Continental Autonomous Mobility Germany GmbH, Ingolstadt (DE)

(21) Appl. No.: 18/877,676

(22) PCT Filed: Jun. 20, 2023
(86) PCT No.: PCT/EP2023/066670

§ 371 Date: Dec. 20, 2024

(30) Foreign Application Priority Data
Jun. 28, 2022 (FR) FR2206453

(51) Int. Cl. G06V 20/58; G06V 10/82

(52) U.S. Cl. CPC G06V 20/58; G06V 10/82

(57) ABSTRACT

A process for detecting objects by a neural network. The neural network being supplied at input with at least one original first optical flow map which represents the computerized tracking of moving objects in a scene by analyzing the differences in content between a first image, captured by an image acquisition device in a first position at an earlier time, and a successive second image, captured by the image acquisition device in a second position at a current time. The process includes rectifying the original optical flow map by using the ego-motion estimation information of the image acquisition device.

### CROSS REFERENCE TO RELATED APPLICATIONS

This application is the U.S. National Phase Application of PCT International Application No. PCT/EP2023/066670, filed Jun. 20, 2023, which claims priority to French Patent Application No. 2206453, filed Jun. 28, 2022, the contents of such applications being incorporated by reference herein.

### FIELD OF THE INVENTION

The invention relates to the field of detecting objects by means of a neural network, and more particularly to an improved process for detecting objects by means of a neural network.

The present invention is particularly designed to be implemented by a computer which equips a vehicle, in particular a motor vehicle, comprising a driving assistance system.

### BACKGROUND OF THE INVENTION

It is known to equip a motor vehicle with a driving assistance system commonly known by the acronym ADAS for “Advanced Driver Assistance System”.

Such an assistance system comprises, as is known, at least one image acquisition device which is mounted on the vehicle and which makes it possible to generate a series of images representing the environment of the vehicle.

The image acquisition device is, for example, a Lidar (acronym for “Light Detection And Ranging”), a camera or a radar.

The captured images are exploited by a computer in order to assist the driver, for example by detecting “objects” such as a pedestrian, a stationary vehicle, or any other object on the road, and by calculating, for example, the time before collision with the detected object.

The information given by the images captured by the image acquisition device makes it possible to implement simultaneous localization and mapping (known by the acronym SLAM for “Simultaneous Localization And Mapping”) in order to make it possible to simultaneously construct and enrich the scene representing the environment of the motor vehicle and also to make it possible to locate the motor vehicle in the scene.

Thus, the use neural networks, also known by the acronym CNN for “Convolutional Neural Networks”, is known.

Neural networks are used to perform a scene perception function and to provide information about various objects present in the environment of the vehicle.

Neural networks are used in particular to provide semantic, detection, motion and location information about objects in the scene.

To this end, the neural network should be trained in learning mode, by supplying it at input with numerous previously labeled images, in order to teach the neural network to recognize objects.

Once the neural network has been trained, it can be used in detection mode to detect and recognize objects.

To do this, the previously trained neural network is supplied with images, for example images captured by an image acquisition device mounted on a motor vehicle.

Thus, it is known to supply a neural network with optical flow maps.

An optical flow map describes and represents the computerized tracking of moving objects by analyzing differences in content between successive video images.

A computer can locate frames of reference marking the boundaries, edges and regions of individual still images.

Detecting their progression allows the computer to track an object in time and space.

In other words, an optical flow map represents the motion of the moving regions, or moving objects, between a first image captured by an image acquisition device in a first position at an earlier time t−1, and a successive second image captured by the image acquisition device in a second position at a current time t.

The direction and the force of the motion of the moving objects are, for example, illustrated by motion vectors on the optical flow map.

In the field of the invention, namely driving assistance, the image acquisition device is in unison, in terms of motion, with the motor vehicle which carries it.

The image acquisition device is attached to a camera frame of reference which comprises a transverse axis, a vertical axis and a longitudinal axis which extends along a main direction of movement of the vehicle from rear to front.

The motion of the image acquisition device, or its ego-motion, comprises six degrees of freedom, namely a transverse translation, a vertical translation from top to bottom, a longitudinal translation, a rotation about the transverse axis called pitch, a rotation about the vertical axis called yaw and a rotation about the longitudinal axis called roll.

During the life time of the vehicle, the vehicle and the image acquisition device will move essentially in the main direction of travel of the vehicle on the road, that is to say in longitudinal translation.

Thus, neural networks are trained with optical flow maps which correspond in the majority to a movement in longitudinal translation, and in the minority to the other movements described above.

Consequently, neural networks will be effective in detecting objects when the vehicle is moving in longitudinal translation.

Conversely, neural networks will be less effective in detecting objects when the motion of the vehicle comprises a component other than a longitudinal translation, such as a skid which corresponds to a lateral translation, a speed bump which corresponds to a translation from top to bottom and to a pitch, a sharp turn which corresponds to a yaw rotation, a pothole which corresponds to a roll rotation or else a strong acceleration of the vehicle which corresponds to a pitch rotation.

Thus, it is observed that the performance of neural networks is limited by the data with which they are supplied.

### SUMMARY OF THE INVENTION

The present invention aims to propose an improved process for detecting objects by means of a neural network which boosts the performance of the neural network, in particular under conditions which correspond to movements of the vehicle other than a longitudinal translation movement in the main direction of travel of the vehicle.

This, as well as other aspects which will become apparent on reading the following description, is achieved with an improved process for detecting objects by means of a neural network, said neural network being supplied at input with at least one original first optical flow map which represents the computerized tracking of moving objects in a scene by analyzing the differences in content between a first image, captured by an image acquisition device in a first position at an earlier time, and a successive second image, captured by said image acquisition device in a second position at a current time, characterized in that it comprises at least:

a first step of estimating the three translation parameters and the three rotation parameters of the ego-motion of the image acquisition device between said first position and said second position, the three translation parameters comprising two secondary translation parameters and one main translation parameter along a longitudinal axis which corresponds to the main movement of the image acquisition device,
a second step which consists in estimating a first rotation matrix which makes it possible to pass from the first position to a first virtual rectified position, and a second rotation matrix which makes it possible to pass from the second position to a second virtual rectified position, such that the two secondary translation parameters and the three rotation parameters which allow the passage from the first rectified position to the second rectified position are equal to zero,.
a third step of normalization which consists in calculating a rectified second optical flow map which is obtained by applying the first rotation matrix and the second rotation matrix to the original first optical flow map, and which represents the computerized tracking of moving objects between the first rectified position and the second rectified position.

Thus, the process according to the invention makes it possible to obtain rectified optical flow maps which ignore parasitic motions of the image acquisition sensor, such as pitch, roll and yaw motions when the image acquisition sensor is mounted on a motor vehicle.

According to other optional features of the invention, taken alone or in combination:
the process comprises a learning step which consists in supplying a neural network with a plurality of rectified optical flow maps according to the third step of normalization of the process, in order to train said neural network. This feature makes it possible to improve the learning performance of the neural network thus supplied with rectified optical flow maps;
the process comprises a detection step which consists in supplying a neural network with a plurality of rectified optical flow maps according to the third step of normalization, in order to carry out object detection. This feature makes it possible to improve the detection performance of the neural network thus supplied with rectified optical flow maps.

The invention also concerns a computer configured to implement the process described above.

Furthermore, the invention concerns a motor vehicle comprising a computer of the type described above, and at least one image acquisition device which is in unison with the motor vehicle in terms of motion, the motor vehicle moving mainly along a longitudinal axis.

### BRIEF DESCRIPTION OF THE DRAWINGS

Other features and advantages of the invention will become apparent on reading the following description, with reference to the appended figures which illustrate:

FIG. 1 a schematic plan view of a motor vehicle equipped with an image acquisition device, in a first, earlier position and in a second, current position;

FIG. 2 a schematic view similar to that of FIG. 1 of the motor vehicle in a first rectified position and in a second rectified position as per the process according to the invention;

FIG. 3 a schematic view of an original first optical flow map;

FIG. 4 a schematic view of a second optical flow map rectified by means of the process according to the invention.

In the description and the claims, the terminology transverse, vertical and longitudinal will be adopted in a non-limiting manner with reference to the transverse axis Xc, to the vertical axis Yc and to the longitudinal axis Zc, respectively, of the camera frame of reference Rc indicated in the figures, considering that the motor vehicle extends longitudinally and moves longitudinally forward.

### DETAILED DESCRIPTION OF EXEMPLARY EMBODIMENTS

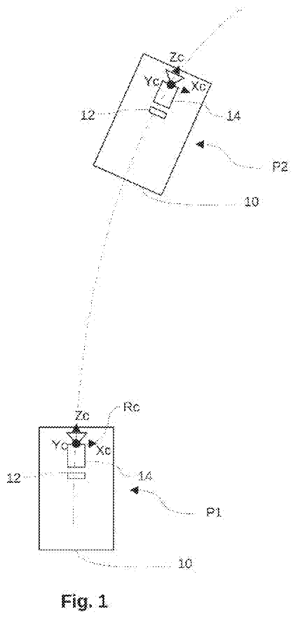

FIG. 1 shows a motor vehicle 10 which is equipped with a computer 12 and an image acquisition device 14.

A camera frame of reference Rc, which is the frame of reference attached to the image acquisition device 14, is considered.

A nominal frame of reference (not shown) which corresponds to the nominal position of the image acquisition device 14, that is to say the theoretical ideal position that the image acquisition device 14 should occupy on the associated motor vehicle 10, is also considered.

The camera frame of reference Rc comprises an axis Xc which extends transversely, an axis Yc which extends vertically and an axis Zc which extends longitudinally along a main direction of movement of the motor vehicle 10, from rear to front.

It will be noted that the image acquisition device 14 is linked to the motor vehicle 10 in terms of motion.

Thus, the motion of the image acquisition device 14, or its ego-motion, comprises six degrees of freedom, namely a degree of freedom which corresponds to a transverse translation along the axis Xc, a degree of freedom which corresponds to a vertical translation from top to bottom along the axis Yc, a degree of freedom which corresponds to a longitudinal translation along the axis Zc, a degree of freedom about the axis Xc which corresponds to a rotation called pitch, a degree of freedom about the axis Yc which corresponds to a rotation called yaw and a degree of freedom about the axis Zc which corresponds to a rotation called roll.

The motor vehicle 10 is equipped with a driving assistance system which aims to assist the driver, for example by analyzing the data provided by the image acquisition device 14, in particular to detect “objects” such as a pedestrian, a stationary vehicle, or any other obstacle on the road.

To this end, the computer 12 of the motor vehicle 10 implements an improved process for detecting objects by means of a neural network, according to the invention.

The neural network is supplied at input with a plurality of optical flow maps.

For reasons of clarity, the operation of the process according to the invention will be described hereinafter with a single optical flow map, called the “original first optical flow map C1”.

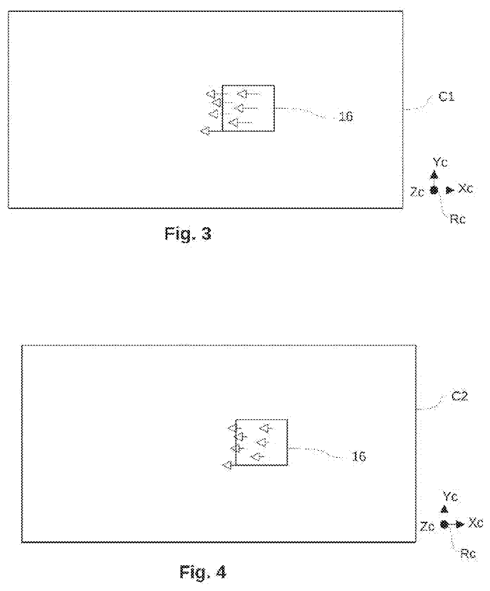

The original first optical flow map C1, illustrated in FIG. 3, represents the computerized tracking of moving objects in a scene, by analyzing the differences in content between two successive images captured by the image acquisition device 14.

With reference to FIG. 1, the images which make it possible to obtain the original first optical flow map C1 comprise a first image captured by the image acquisition device 14 in a first position P1 at an earlier time, and a successive second image captured by the image acquisition device 14 in a second position P2 at a current time.

The process according to the invention comprises a first step of estimating the ego-motion of the image acquisition device 14.

The first step consists in estimating the three translation parameters and the three rotation parameters of the ego-motion of the image acquisition device 14 between the first position P1 and the second position P2.

The three translation parameters comprise a main translation parameter along the longitudinal axis Zc of main movement of the image acquisition device 14 and two secondary translation parameters along the vertical axis Yc and along the transverse axis Xc of the camera frame of reference Rc.

The estimation of the ego-motion of the image acquisition device 14 can be obtained by various methods, such as a simultaneous localization and mapping method known by the acronym SLAM for “Simultaneous Localization And Mapping”, or by means of the data provided by an inertial sensor carried by the motor vehicle 10, or else by means of a geolocation system.

After the first step, the process executes a second step which consists in estimating a transformation matrix which makes it possible to pass from a first virtual rectified position P3 to a second virtual rectified position P4 of the image acquisition device 14.

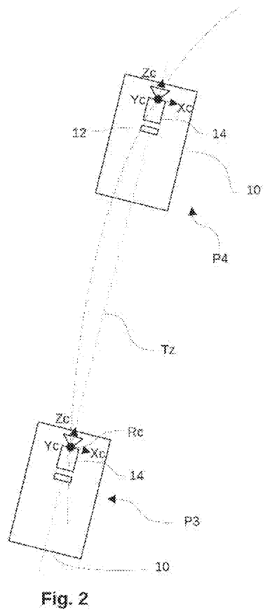

As can be seen in FIG. 2, the passage from the first rectified position P3 to the second rectified position P4 only requires a longitudinal translation along the longitudinal axis Zc, which is illustrated by a dotted line Tz in FIG. 2.

The longitudinal translation along the longitudinal axis Zc corresponds to the main direction of movement of the assembly formed by the motor vehicle 10 and the image acquisition device 14.

Thus, the second step consists in estimating a first rotation matrix which makes it possible to pass from the first position P1 to the first virtual rectified position P3, and a second rotation matrix which makes it possible to pass from the second position P2 to the second virtual rectified position P4, such that the two secondary translation parameters and the three rotation parameters which allow the passage from the first rectified position P3 to the second rectified position P4 are equal to zero.

Following the second step, the process executes a third step of normalization which consists in calculating a rectified second optical flow map C2, illustrated in FIG. 4, which is obtained by applying the first rotation matrix and the second rotation matrix to the original first optical flow map C1.

The rectified second optical flow map C2 represents the computerized tracking of moving objects between the first rectified position P3 and the second rectified position P4 of the image acquisition device 14.

Thus, the rectified second optical flow map C2 has the advantage of rectifying the optical flows represented by the motion vectors in FIGS. 3 and 4, such that the passage from the first rectified position P3 to the second rectified position P4 is limited to a longitudinal translation along the longitudinal axis Zc of travel of the motor vehicle 10.

An exemplary implementation of the process according to the invention is described below.

With reference to FIG. 1, the image acquisition device 14 draws a curved trajectory to move from the first position P1 to the second position P2, which translates into a rotation of the image acquisition device 14, and of the motor vehicle 10, about the vertical axis Yc.

This curved trajectory is illustrated by a dotted axis line in FIGS. 1 and 2.

The ego-motion of the image acquisition device 14 is estimated during the first estimation step of the process.

Next, during the second step of the process, a first rotation matrix which makes it possible to pass from the first position P1 to the first virtual rectified position P3, and a second rotation matrix which makes it possible to pass from the second position P2 to the second virtual rectified position P4 are estimated such that the two secondary translation parameters and the three rotation parameters which allow the passage from the first rectified position P3 to the second rectified position P4 are equal to zero.

As can be seen in FIG. 3, which illustrates the original first optical flow map C1, a plurality of motion vectors represent the tracking of an object 16, by analyzing the differences in content between the first image captured by the image acquisition device 14 in the first position P1 and the second image captured by the image acquisition device 14 in the second position P2.

FIG. 4 shows the rectified second optical flow map C2 calculated during the third step of normalization of the process.

It will be noted that the motion induced by the curved trajectory of the motor vehicle 10, which corresponds to a rotation of the acquisition sensor 14 about the vertical axis Yc, is compensated for.

This compensation translates into a reduction in the length of the motion vectors of FIG. 4, i.e. a suppression of the bias caused by the curved trajectory of the motor vehicle 10.

It will be understood that the process according to the invention is designed to correct a bias caused by any motion other than a longitudinal translation along the axis Zc, such as a skid which corresponds to a lateral translation along the axis Xc, a speed bump which corresponds to a translation from top to bottom along the axis Yc and/or a rotation about the axis Xc, a sharp turn which corresponds to a yaw rotation about the axis Yc, a pothole which corresponds to a roll rotation about the axis Zc, or else a strong acceleration of the vehicle which corresponds to a pitch rotation about the axis Xc.

The process according to the invention can be used in object detection mode and in learning mode.

In detection mode, the process comprises a detection step which consists in supplying a neural network with a plurality of rectified optical flow maps according to the third step of normalization.

The detection mode makes it possible to improve the performance of the neural network to detect objects in numerous situations, in particular in the above-mentioned pitch, roll, yaw and other situations.

In learning mode, the process comprises a learning step which consists in supplying a neural network with a plurality of rectified optical flow maps according to the third step of normalization in order to train the neural network.

The learning mode makes it possible to improve the performance of the neural network trained by the process according to the invention.

Naturally, the invention is described in the preceding text by way of example. It is understood that a person skilled in the art is able to produce various variant embodiments of the invention without thereby departing from the scope of the invention.

For example, it is possible to compensate for and correct a significant inclination of the image acquisition device 14 in certain elevated vehicles, such as trucks, or to correct a mounting error of the image acquisition device 14 with respect to its theoretical nominal position.

To this end, a suitable transformation is applied between the camera frame of reference Rc, which is the frame of reference attached to the image acquisition device 14, and the nominal frame of reference which corresponds to the nominal position of the image acquisition device 14, following the second step of the process.

This transformation consists, for example, in applying an additional rotation matrix to the original first optical flow map C1 during the third step, in order to correct a mounting error of the image acquisition device 14 with respect to its theoretical nominal position.

1. An improved process for detecting objects by a neural network, said neural network being supplied at input with at least one original first optical flow map which represents the computerized tracking of moving objects in a scene by analyzing the differences in content between a first image, captured by an image acquisition device in a first position at an earlier time, and a successive second image, captured by said image acquisition device in a second position at a current time, characterized in that it comprises at least:
a first step of estimating the three translation parameters and the three rotation parameters of the ego-motion of the image acquisition device between said first position and said second position, the three translation parameters comprising two secondary translation parameters and one main translation parameter along a longitudinal axis which corresponds to the main movement of the image acquisition device,
a second step which consists in estimating a first rotation matrix which makes it possible to pass from the first position to a first virtual rectified position, and a second rotation matrix which makes it possible to pass from the second position to a second virtual rectified position, such that the two secondary translation parameters and the three rotation parameters which allow the passage from the first rectified position to the second rectified position are equal to zero,
a third step of normalization which consists in calculating a rectified second optical flow map which is obtained by applying the first rotation matrix and the second rotation matrix to the original first optical flow map, and which represents the computerized tracking of moving objects between the first rectified position and the second rectified position.

2. The improved process for detecting objects by a neural network as claimed in claim 1, further comprising a learning step which consists in supplying a neural network with a plurality of rectified optical flow maps according to the third step of normalization of the process, in order to train said neural network.

3. The improved process for detecting objects by a neural network as claimed in claim 1, further comprising a detection step which consists in supplying a neural network with a plurality of rectified optical flow maps according to the third step of normalization, in order to carry out object detection.

4. A computer configured to implement the process as claimed in claim 1.

5. A motor vehicle comprising a computer as claimed in claim 4 and at least one image acquisition device which is in unison with the motor vehicle in terms of motion, the motor vehicle moving mainly along a longitudinal axis.

6. The improved process for detecting objects by a neural network as claimed in claim 2, further comprising a detection step which consists in supplying a neural network with a plurality of rectified optical flow maps according to the third step of normalization, in order to carry out object detection.
